(19) United States
(12) Patent Application Publication
(10) Pub. No.: US 2014/0280178 A1
(43) Pub. Date: Sep. 18, 2014

(54) Systems and Methods for Labeling Sets of Objects

(71) Applicant: CitizenNet Inc., Culver City, CA (US)

(72) Inventors: Daniel Benyamin, Los Angeles, CA (US); Aaron Chu, Los Angeles, CA (US)

(73) Assignee: CitizenNet Inc., Culver City, CA (US)

(21) Appl. No.: 14/204,206

(22) Filed: Mar. 11, 2014

Related U.S. Application Data
(60) Provisional application No. 61/786,641, filed on Mar. 15, 2013.

(51) Int. Cl. G06F 17/30

(52) U.S. Cl. CPC G06F 17/30598
USPC 707/740

(57) ABSTRACT

Systems and methods for labeling sets of objects using a taxonomy in accordance with embodiments of the invention are disclosed. In one embodiment, an object labeling server system includes a processor configured to obtain a set of object data including a set of keywords, score the object data based on a taxonomy including resource data, category information, relationships between the category information and resource data, and relationships between the category information, cluster the object data into groups of object data based on the scores, determine category data for at least one of the groups of object data based on the taxonomy, and generate a label for at least one of the groups of object data based on the determined category data for the group of object data.

### CROSS-REFERENCE TO RELATED APPLICATIONS

The current application claims priority to U.S. Provisional Patent Application Ser. No. 61/786,641, filed Mar. 15, 2013, the disclosure of which is hereby incorporated by reference in its entirety.

### FIELD OF THE INVENTION

The present invention relates to labeling objects and more specifically to the labeling sets of objects using a taxonomy.

### BACKGROUND

Online social networks, such as the Facebook service provided by Facebook, Inc. of Palo Alto, Calif., are ad networks that have very good knowledge of the visitors to specific pages within the online social network. In order to visit a page within a social network, one typically needs to be a member of the social network. In addition, members of social networks typically provide demographic information and information concerning interests in order to personalize their behavior. For example, a Facebook member could indicate that they are interested in ski vacations to Lake Tahoe by clicking a “Like” button featured on a Lake Tahoe website. A simple advertising strategy would be to target the members of an online social network who have previously indicated interest in the product or service being offered by the advertisement. A flaw with this strategy, however, is that many members that are interested in the advertised offer are not being targeted, because they have not previously indicated a desire for the products or services. A campaign can be further targeted using keywords to narrow the audience for an advertisement to people who have interests that correlate with the advertised offer. In many ad networks, advertisers can bid on keywords. Therefore, targeting users associated with a first keyword can cost significantly more money than targeting users associated with a second keyword. Returning to the example of an advertiser of ski travel packages to Lake Tahoe, the question becomes: who are others that may be interested in a Lake Tahoe vacation package beyond those that have specifically expressed an interest in such a vacation? Probably those who like specific ski resorts would be good candidates, and possibly those who like specific ski manufacturers. What about those who like gambling? Since the Lake Tahoe area also features a number of casinos, the desired audience for the offer could include members that like to ski and like to play poker. However, not all who like to play poker are good candidates for such a vacation package, and as such, advertisement budgets may not be wisely spent on such an audience.

Recent advances in online advertising have most prominently been in the field of behavioral targeting. Both web sites and networks tailor their online experiences to individuals or classes of individuals through behavioral targeting. When employed by advertising networks (“ad networks”), behavioral targeting matches advertisers that have a certain desired target audience with websites that have been profiled to draw a specific audience. One of the challenges in behavioral targeting is determining the true extent of the match between a desired audience and the actual audience drawn by a specific web page.

### SUMMARY OF THE INVENTION

Systems and methods for labeling sets of objects using a taxonomy in accordance with embodiments of the invention are disclosed. In one embodiment, an object labeling server system includes a processor and a memory connected to the processor and configured to store an object labeling application, wherein the object labeling application configures the processor to obtain a set of object data, where the object data includes a set of keywords, score the object data in the set of object data based on a taxonomy, where the taxonomy includes resource data, category information describing the resource data, relationships between the category information and resource data, and relationships between the category information, cluster the object data into groups of object data based on the scores, where pieces of object data in a group of object data have similar scores, determine category data for at least one of the groups of object data based on the taxonomy, where the category data includes category information taken from the taxonomy based on the keywords associated with the pieces of object data within a group of object data, and generate a label for at least one of the groups of object data based on the determined category data for the group of object data.

In another embodiment of the invention, the object labeling application further configures the processor to discard outlier groups of object data.

In an additional embodiment of the invention, an outlier group of object data has a size below a threshold value, where the size of the outlier group is based on the number of pieces of object data within the group of object data.

In yet another additional embodiment of the invention, an outlier group of object data includes at least one piece of object data having a score below a threshold value.

In still another additional embodiment of the invention, the object labeling application configures the processor to score the object data by determining the category intersection count for pairs of keywords in the object data by locating each keyword within the taxonomy and determining the number of categories in common for each pair of keywords.

In yet still another additional embodiment of the invention, the object labeling application configures the processor to determine the number of categories in common by locating a particular number of categories for each keyword within the taxonomy and counting the number of categories in common between the keywords.

In yet another embodiment of the invention, the object labeling application configures the processor to determine the number of categories in common by progressively traversing the relationships between categories for each keyword until a common category is located and the category intersection count includes the number of relationships traversed until a common category is reached.

In still another embodiment of the invention, the object labeling application configures the processor to determine the number of categories in common by measuring the average category level for a keyword by determining the category level for each intersecting category found in the determination of the category intersection count for a given keyword, measuring the distance the category is from the keyword based on the taxonomy, and dividing the sum of the category levels by the number of intersecting categories.

In yet still another embodiment of the invention, the distance the category is from the keyword is based on the number of relationships between the keyword and the category within the taxonomy.

In yet another additional embodiment of the invention, the object labeling application configures the processor to score the set of object data based on a category inverse document frequency of the keywords in the object data in the set of object data and the category inverse document frequency is a representation of the frequency of the keywords within the set of object data.

In still another additional embodiment of the invention, the object labeling application configures the processor to determine the category inverse document frequency of a keyword by determining if the keyword appears in a resource page, dividing the total number of resources within the taxonomy corresponding to the keyword by the number of resources containing a relationship with category in the taxonomy, and calculating the logarithm of the divided total number of resources.

In yet still another additional embodiment of the invention, determining if the keyword appears in a resource page is a Boolean value representing the appearance of the in the resource page.

In yet another embodiment of the invention, the resource page is taken from an information source remote from the object labeling server system.

In still another embodiment of the invention, the object labeling application configures the processor to label the groups of object data by creating a composite description based on the determined category data for a particular group of object data.

In yet still another embodiment of the invention, the composite description is grammatically correct.

In yet another additional embodiment of the invention, the object labeling application further configures the processor to disambiguate the set of object data by comparing one or more of the words within the set of words to a disambiguation database.

In still another additional embodiment of the invention, the disambiguation database includes the taxonomy stored on the object labeling server system.

In yet still another additional embodiment of the invention, the disambiguation database includes at least one information source that provides a disambiguation service and the information source is separate from the object labeling server system.

In yet another embodiment of the invention, the disambiguation of a set of keywords within the set of object data depends on the context of the keywords within the set of object data and the object labeling application configures the processor to determine the context of the keywords based on the grammatical context of the keyword within the set of object data.

In still another embodiment of the invention, the disambiguation of a keyword includes substituting an updated keyword taken from the disambiguation database for the keyword.

In yet still another embodiment of the invention, the disambiguation of a keyword includes adding additional keywords taken from the disambiguation database to the set of object data.

Yet another embodiment of the invention includes a method for labeling sets of objects including obtaining a set of object data using an object labeling server system, where the object data includes a set of keywords, scoring the object data in the set of object data based on a taxonomy using the object labeling server system, where the taxonomy includes resource data, category information describing the resource data, relationships between the category information and resource data, and relationships between the category information, clustering the object data into group of object data based on the scores using the object labeling server system, where pieces of object data in a group of object data have similar scores, determining category data for at least one of the groups of object data based on the taxonomy using the object labeling server system, where the category data includes category information taken from the taxonomy based on the keywords associated with the pieces of object data within a group of object data, and generating a label for at least one of the groups of object data based on the determined category data for the group of object data using the object labeling server system.

### BRIEF DESCRIPTION OF THE DRAWINGS

FIG. 1 is a conceptual illustration of an object labeling system in accordance with an embodiment of the invention.

FIG. 2 is a conceptual illustration of an object labeling device in accordance with an embodiment of the invention.

FIG. 3 is a flow chart illustrating a process for labeling a set of objects in accordance with an embodiment of the invention.

FIG. 4 is a conceptual illustration of a resource page provided by an information source in accordance with an embodiment of the invention.

### DETAILED DESCRIPTION

Turning now to the drawings, systems and methods for labeling sets of objects in accordance with embodiments of the invention are disclosed. Members of online social networks post messages about a variety of topics. Targeted advertising campaigns are designed to present advertisements to the members of an online social network based on the topics discussed. However, the messages often do not identify (or misidentify) the actual topic of the message. Object labeling server systems in accordance with embodiment of the invention are configured to determine accurate labels for a set of objects, such as words appearing in one or more messages on an online social network. In the case of messages, the label for the words in the message can be the topic of the message. Likewise, a label for a set of messages can identify what multiple users are discussing on the online social network.

Object labeling server systems are configured to utilize taxonomies (described below) to score each object appearing in the set of objects. Based on the scores, the objects are clustered into groups of related objects. Categories are determined for the object clusters and, if there is more than one object cluster within the set of objects, the categories are combined to create one overarching label describing the set of objects. In a variety of embodiments, outlier objects are discarded from the set of objects in order to improve the accuracy of the labeling process. In cases where the labeled sets of objects are words from an online social network, targeted advertising servers can generate targeted advertising campaigns that reflect the topics of the messages posted on online social network(s). Systems and methods for creating targeting advertising campaigns that can be utilized in accordance with embodiments of the invention are disclosed in U.S. patent application Ser. No. 12/467,981 to Benyamin et al., titled “Social Advertisement Network” and filed May 18, 2009, the entirety of which is hereby incorporated by reference.

Although the above describes sets of words taken from online social networking messages, any arbitrary sets of objects (e.g. words, images, audio data, video data, etc. . . . ) can be labeled as appropriate to the requirements of a specific application in accordance with embodiments of the invention. Likewise, the uses of labeled sets of objects are in no way limited to targeting advertising on online social networks. Additionally, any of the various systems and processes described herein can be performed in alternative sequences and/or in parallel (on different computing devices) in order to achieve similar results in a manner that is more appropriate to the requirements of a specific application. Systems and methods for labeling sets of objects in accordance with embodiments of the invention are discussed below.

### Taxonomies for the Labeling of Objects

A variety of information sources exist in the world today, such as the Netflix service provided by Netflix, Inc. for movies, the last.fm service provided by CBS Interactive for music, the Google Maps service provided by Google, Inc. for local business information, and the Wikipedia service provided by the Wikimedia Foundation for a wide variety of topics. Several databases exist providing structured indices and descriptions about the data stored in a number of these sources of information, such as the DBpedia service provided by OpenLink Software, Inc. and the Google Freebase project provided by Google, Inc. However, not every data source contains information about every possible object that could appear within a set of objects. Taxonomies in accordance with embodiments of the invention include resources taken from one or more information sources and/or databases along with category information describing the resources, relationships between the categories and resources, and relationships between the categories. It should be noted that the word taxonomy as used herein does not imply a hierarchical relationships within the taxonomy; rather, the taxonomy is any organization of categories, relationships, and resources as appropriate to the requirements of a specific application in accordance with embodiments of the invention.

Categories within the taxonomy identify concepts or other information utilized in the organization and location of resources. In several embodiments, a category contains a name or other identifier providing a human-readable description of the category. Many webpages within an information source are known as ‘category’ or ‘disambiguation’ pages that link to other category or resource pages. These links can be to pages within the information source and/or to external information sources. Based on these category pages, categories within the taxonomy are defined with the links to other webpages providing the basis for defining relationships between the categories and the other categories and/or resources. In the taxonomy, resources include topic(s) that describing the content of the resource along with keywords and other information related to the topic. Resources within the taxonomy often correspond to webpages within an information source containing information about the topic such as keywords and other descriptive data. For example, a taxonomy can include the resource ‘Omega Watches’ that contains keywords such as ‘Speedmaster’ and ‘Seamaster’ along with information describing the particular watches provided by Omega SA and information regarding Omega SA itself. The “Omega Watches” resource likely contains references to the “Omega Speedmaster” resource and the “Omega Seamaster” resource, where those resources contain keywords and information regarding the history and features of those particular watches. Similarly, the “Omega Speedmaster” resource contains a relationship with the “NASA” resource as the Omega Speedmaster is the first watch qualified for space missions and the “Omega Seamaster” resource contains a relationship with the “James Bond” resource as the Omega Seamaster is James Bond's watch of choice.

Relationships between categories and resources within the taxonomy can indicate the specific (directional) relationship between the related entities. Based on these relationships, resources can act as categories for other resources. For example, for the category “Rock Bands” and the resource “The Beatles,” an ‘is-a’ relationship exists from “The Beatles” to “Rock Band” as the Beatles were a rock band. Likewise, for the resources “Paul McCartney” and “The Beatles,” a “band member of” relationship exists between “Paul McCartney” and “The Beatles” because Paul McCartney was in the Beatles. Likewise, the resource “The Beatles” can serve as a category for the resources “Paul McCartney,” “John Lennon,” “Ringo Starr,” “George Harrison,” “Peter Best,” “Stuart Sutcliffe,” and less popularly, “Yoko Ono.” When labeling objects containing the terms “Paul McCartney” and “Ringo Starr,” based on the relationships between the corresponding resources indicates that the topic of the object may be “The Beatles” as both resources contain a relationship with “The Beatles.”

Turning now to FIG. 4, an example illustrating a resource page that can be provided by an information source in accordance with an embodiment of the invention is shown. The resource page 400 includes a category 410, a set of related categories 420, a set of related resources 430, and a set of metadata 440. The category 410 indicates the category of the current page, while the set of related categories 420 indicates that a relationship exists between the category 410 and each category within the set of related categories 420. Similarly, a relationship also exists between the category 410 and each of the resources within the set of related resources 430. Metadata 440 includes keywords and other descriptive information regarding the category 410, related categories 420, and/or related resources 430. In several embodiments, the metadata 440 includes keywords that can be utilized to generate a label for objects associated with the category 410. These categories, resources, metadata, and the relationships between them can be utilized to create and/or augment the taxonomy used to generate labels for sets of objects in accordance with the requirements of specific embodiments of the invention. Although a specific resource page is shown in FIG. 4, any resource page provided by any information source, including those containing only a subset of the data described above, can be utilized in accordance embodiments of the invention as described herein.

In a variety of embodiments, taxonomies include disambiguation information that can be utilized to clarify objects with multiple meanings (e.g. the term ‘oasis’ can refer to both a band and an isolated area of vegetation in a desert based on the context of the term ‘oasis’) and/or map obscure and/or obsolete terms to more commonly known definitions. For example, the phrase ‘Lew Alcindor’ refers to the basketball player more commonly known as Kareem Abdul-Jabaar; likewise, Cassius Clay is more commonly known as Muhammad Ali. The disambiguation information allows for more accurate location of categories and resources within the taxonomy by utilizing terms that are more likely to appear within the taxonomy.

In several embodiments, the taxonomy can be utilized to create a set of training data based on messages obtained from one or more online social networks. Utilizing a set of training messages, the taxonomy can be utilized to identify keywords (e.g. keyword components) within the training messages to identify one or more categories and/or resources associated with the training messages from the online social network. In many embodiments, the training data includes a portion of the keywords from the training messages along with a portion of the categories, resources, and/or keywords associated with the categories and resources within the taxonomy. This training data can then be utilized in the creation of targeted advertising campaigns utilizing techniques similar to those in U.S. patent application Ser. No. 12/781,799 to Benyamin et al., titled “Social Network Message Categorization Systems and Methods’ and filed May 17, 2010, the entirety of which is hereby incorporated by reference. Additionally, additional training messages can be continuously retrieved (or on a schedule) from the online social network. In this way, the training data can be updated to reflect trending topics within the online social network based on the messages posted to the online social network, allowing for the more accurate categorization of target messages. The accurate categorization of target messages facilitates the effective targeting of advertisements based on those target messages.

### Object Labeling Systems

Object labeling systems are configured to provide labels for sets of objects based on a taxonomy. The labeled sets of objects can be utilized in a variety of contexts, including targeted advertising. A diagram of an object labeling system in accordance with an embodiment of the invention is shown in FIG. 1. The object labeling system 100 includes an object labeling server system 110, one or more online social networks 112, one or more information sources 114, and user devices including computers 130, tablets 132, and mobile phones 134 configured to communicate via a network 120. In a variety of embodiments, the network 120 is the Internet. In a number of embodiments, the object labeling server system 110 is implemented using a single server system. In several embodiments, the object labeling server system 110 is implemented using multiple server systems.

In many embodiments, the object labeling server system 110 is configured to receive a set of objects from the user devices. In several embodiments, the user devices are configured to post messages to the online social network 112 and the object labeling server system 110 is configured to receive a set of objects including one or more messages from the online social network 112 and/or an advertising server system configured to generate targeted advertising for the online social network 112. The object labeling server system 110 is configured to disambiguate the objects in the set of objects, cluster the objects into groups, determine categories for the groups of objects, and generate at least one label describing the groups of objects based on the categories. The object labeling server system 110 can process the set of objects, categorize the objects, and generate labels for the set of objects using a variety of information, such as a taxonomy containing categories, resources, and relationships describing one or more objects in the set of object and/or querying the information sources 114 to obtain information regarding the objects. In a number of embodiments, the taxonomy is generated using information contained in the information sources 114.

Although a specific architecture of an object labeling system in accordance with embodiments of the invention are discussed above and illustrated in FIG. 1, a variety of architectures, including user devices not specifically named and other methods of receiving and utilizing labeled objects can be utilized in accordance with embodiments of the invention. Systems and methods for labeling sets of objects are discussed below.

### Object Labeling Server Systems

Object labeling server systems in accordance with embodiments of the invention are configured to label sets of objects using a taxonomy. A conceptual illustration of an object labeling server system in accordance with an embodiment of the invention is shown in FIG. 2. The object labeling server system 200 includes a processor 210 in communication with memory 230. The object labeling server system 200 also includes a network interface 220 configured to send and receive data over a network connection. In a number of embodiments, the network interface 220 is in communication with the processor 210 and/or the memory 230. In several embodiments, the memory 230 is any form of storage configured to store a variety of data, including, but not limited to, an object labeling application 232, a taxonomy 234, and object data 236. In many embodiments, the object labeling application 232, a taxonomy 234, and object data 236 are stored using an external server system and received by the object labeling server system 200 using the network interface 220.

The processor 210 is configured by the object labeling application 232 to obtain object data 236 including one or more sets of objects and to generate labels for the object data 236 using the taxonomy 234. As described in more detail below, the object labeling application 232 configures the processor 210 to label object data 236 by scoring the objects using the taxonomy 234, clustering the objects into groups based on the scores, determining categories for one or more of the groups of objects using the taxonomy 234, and generating a label for the object data 236 based on the categories. In a variety of embodiments, the object labeling application 232 further configures the processor 210 to transmit the labeled object data to an online social network and/or an advertising server system for use in the generation of targeted advertising campaigns.

Although a specific architecture for a product advertising server system in accordance with an embodiment of the invention is conceptually illustrated in FIG. 2, any of a variety of architectures, including those which store data or applications on disk or some other form of storage and are loaded into memory at runtime and systems that are distributed across multiple physical servers, can also be utilized in accordance with embodiments of the invention. Methods for labeling sets of objects in accordance with embodiments of the invention are discussed below.

### Labeling Sets of Objects

Labels associated with a set of objects give context and provide meaning to the objects within the set. The meaning allows for the effective identification and use of the objects. These uses include, but are not limited to, determining the meaning of terms within online social networking messages to better target advertisements to terms based on the meanings of the terms. Object labeling server systems in accordance with embodiments of the invention are configured to label sets of objects utilizing a taxonomy. The process below is described with respect to labeling a set of words; however, the process below can be applied to any type of object as appropriate to the requirements of a specific application in accordance with embodiments of the invention. Likewise, the term word is used in the sense of text data; a word can contain a single word and/or a group of words forming a phrase. A process for labeling sets of words in accordance with an embodiment of the invention is illustrated in FIG. 3. The process 300 includes obtaining (310) a set of words. In many embodiments, the words are disambiguated (312). The words are scored (314) and clustered (316) into groups. In a variety of embodiments, outlying groups are discarded (318). The groups are categorized (320) and the set of words is labeled (322).

In several embodiments, a set of words is obtained (310) as described above. In a variety of embodiments, the set of words is filtered to remove any stop words (e.g. any undesired common words) and/or punctuation as appropriate to the requirements of a specific application in accordance with embodiments of the invention. Words can be disambiguated (312) by comparing one or more of the words within the set of words to a disambiguation database, such as a taxonomy and/or an information source that provides a disambiguation service such as a disambiguation page on Wikipedia. Disambiguation (312) of words often depends on the context of the word, so multiple words within the set of words and/or the properties of the words themselves (e.g. punctuation or grammar associated with the words) can be used to determine if a particular word should be replaced and/or to determine the actual meaning of the word. For example, if the word ‘Oasis’ is coupled with the words ‘adventure films’, the disambiguation (312) of the word ‘Oasis’, based on the additional words and the capital ‘O,’ likely refers to the 1955 film of the same name. Disambiguating (312) a word can result in words being substituted for the ambiguous word, additional terms being added to the set of words, and/or metadata describing the disambiguated meaning(s) of the set of words can be associated with the set of words. In many embodiments, disambiguating (312) words is performed utilizing processes similar to those described in U.S. patent application Ser. No. 12/781,799, the entirety of which is incorporated by reference above.

Scoring (314) the words includes determining the semantic distance between the words. In a variety of embodiments, semantic distance is a measure of the similarity of a group of words. In many embodiments, the semantic distance of a group of words is determined by determining a set of feature data for each word then calculating a score for each word based on the normalized weighted sum of the feature data for the word. A variety of features can be calculated for a word, including, but not limited to a category intersection count, the average category level, category inverse document frequency, property intersection, and resource existence. Other measures of word similarity, including other word features, can be utilized as appropriate to the requirements of a specific application in accordance with embodiments of the invention.

Determining the category intersection count for a pair of words includes locating each word within the taxonomy and determining the number of categories in common. In a variety of embodiments, determining the number of categories in common includes locating a particular number of categories for each word within the taxonomy (the number can be pre-determined and/or determined dynamically) and counting the number of categories in common between the words. The category intersection count can also be determined in accordance with embodiments of the invention by progressively traversing the relationships between categories for each word until a common category is located; the category intersection count is then the number of relationships traversed until a common category is reached.

The average category level for a word can be measured by determining the category level for each intersecting (i.e. common) category found in the determination of the category intersection count and measuring how far the category is from the word (e.g. the number of relationships between the word and the category), then dividing the sum of the category levels by the number of intersecting categories.

The category inverse document frequency is a representation of the concept that the less common a category and/or resource, the more likely that the category and/or resource is a good indicator of the true category of the word. Determining if a word appears in a resource page is a Boolean value representing yes, the word appears in the resource page or no, the word does not appear. The category inverse document frequency can be determined by dividing the total number of resources within the taxonomy corresponding to the word by the number of resources containing a relationship with category in the taxonomy and then taking the logarithm of the result.

Based on the scores for each word, the words are clustered (316) into groups with words with similar scores being clustered together. Clustering (316) words into groups allows for a more accurate categorization (and therefore labeling) of the words within the set of words by providing insights into particular subgroups of words expressing topics that are prevalent within the set of words. For example, if the set of words includes “John Lennon,” “Ringo Starr,” and “George Harrison,” the broad label “Musicians” can be applied because all three words describe musicians. However, by clustering (316) the three words into a group, the category “Members of the Beatles” can be applied to the group, providing a more detailed description of the meaning of the three words. In a variety of embodiments, clustering (316) words into a group includes identifying pairs of words having a semantic distance (described above) within a threshold value that can be pre-determined and/or determined dynamically. Other clustering techniques can be utilized to cluster (316) words into groups as appropriate to the requirements of a specific application in accordance with embodiments of the invention.

In a number of embodiments, groups with few words indicate those words that are not (as) related to the same topic and/or categories as words in other groups having more words. In several embodiments, groups with words below a threshold value (pre-determined and/or determined dynamically) are discarded (318) and/or ignored as being outliers relative to the set of words. By eliminating groups of words that are not well-correlated with the other words, the accuracy and/or utility of the label for the set of words can be improved. In several embodiments, eliminated groups of words have a cardinality (e.g. the number of words within the group) below a threshold value. The groups of words are categorized (320) by determining a category (and/or the title of a resource) within the taxonomy based on one or more of the words within the group, where the words have been identified as being described by the category and/or resource within the taxonomy. Identifying that words are described by a category and/or resource within the taxonomy utilizes the score associated with the words as described above, although any method for determining the category for a word, including processes described in U.S. patent application Ser. No. 12/781,799, can be utilized as appropriate to the requirements of a specific application in accordance with embodiments of the invention. Labeling (322) the set of words includes utilizing the category (320) for each group of words to create a composite description. If only one category has been identified, the name of the category is the label (322) for the set of words. In multiple categories have been identified, the names of the categories can be combined using any of a variety of linguistic techniques to create a composite description including a (possibly grammatically correct) description including the names of the categories. Furthermore, if multiple categories have been identified, a subset of the identified category names can be utilized to create the composite description.

Specific processes for labeling set of objects in accordance with embodiments of the invention is described above with respect to FIG. 3; however, any number of processes can be utilized as appropriate to the requirements of a specific application in accordance with embodiments of the invention. Additional processes for labeling sets of objects utilizing information sources in accordance with embodiments of the invention are described below.

Although the present invention has been described in certain specific aspects, many additional modifications and variations would be apparent to those skilled in the art. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. An object labeling server system, comprising:
a processor; and
a memory connected to the processor and configured to store an object labeling application;
wherein the object labeling application configures the processor to:
obtain a set of object data, where the object data comprises a set of keywords;
score the object data in the set of object data based on a taxonomy, where the taxonomy comprises resource data, category information describing the resource data, relationships between the category information and resource data, and relationships between the category information;
cluster the object data into groups of object data based on the scores, where pieces of object data in a group of object data have similar scores;
determine category data for at least one of the groups of object data based on the taxonomy, where the category data comprises category information taken from the taxonomy based on the keywords associated with the pieces of object data within a group of object data; and
generate a label for at least one of the groups of object data based on the determined category data for the group of object data.

2. The object labeling server system of claim 1, wherein the object labeling application further configures the processor to discard outlier groups of object data.

3. The object labeling server system of claim 2, wherein an outlier group of object data has a size below a threshold value, where the size of the outlier group is based on the number of pieces of object data within the group of object data.

4. The object labeling server system of claim 2, wherein an outlier group of object data comprises at least one piece of object data having a score below a threshold value.

5. The object labeling server system of claim 1, wherein the object labeling application configures the processor to score the object data by determining the category intersection count for pairs of keywords in the object data by:
locating each keyword within the taxonomy; and
determining the number of categories in common for each pair of keywords.

6. The object labeling server system of claim 5, wherein the object labeling application configures the processor to determine the number of categories in common by:
locating a particular number of categories for each keyword within the taxonomy; and
counting the number of categories in common between the keywords.

7. The object labeling server system of claim 5, wherein:
the object labeling application configures the processor to determine the number of categories in common by progressively traversing the relationships between categories for each keyword until a common category is located; and
the category intersection count comprises the number of relationships traversed until a common category is reached.

8. The object labeling server system of claim 5, wherein the object labeling application configures the processor to determine the number of categories in common by measuring the average category level for a keyword by:
determining the category level for each intersecting category found in the determination of the category intersection count for a given keyword;
measuring the distance the category is from the keyword based on the taxonomy; and
dividing the sum of the category levels by the number of intersecting categories.

9. The object labeling system of claim 8, wherein the distance the category is from the keyword is based on the number of relationships between the keyword and the category within the taxonomy.

10. The object labeling server system of claim 1, wherein:
the object labeling application configures the processor to score the set of object data based on a category inverse document frequency of the keywords in the object data in the set of object data; and
the category inverse document frequency is a representation of the frequency of the keywords within the set of object data.

11. The object labeling server system of claim 10, wherein the object labeling application configures the processor to determine the category inverse document frequency of a keyword by:
determining if the keyword appears in a resource page;
dividing the total number of resources within the taxonomy corresponding to the keyword by the number of resources containing a relationship with category in the taxonomy; and
calculating the logarithm of the divided total number of resources.

12. The object labeling server system of claim 11, wherein determining if the keyword appears in a resource page is a Boolean value representing the appearance of the in the resource page.

13. The object labeling server system of claim 11, wherein the resource page is taken from an information source remote from the object labeling server system.

14. The object labeling server system of claim 1, wherein the object labeling application configures the processor to label the groups of object data by creating a composite description based on the determined category data for a particular group of object data.

15. The object labeling server system of claim 14, wherein the composite description is grammatically correct.

16. The object labeling server system of claim 1, wherein the object labeling application further configures the processor to disambiguate the set of object data by comparing one or more of the words within the set of words to a disambiguation database.

17. The object labeling server system of claim 16, wherein the disambiguation database comprises the taxonomy stored on the object labeling server system.

18. The object labeling server system of claim 16, wherein:
the disambiguation database comprises at least one information source that provides a disambiguation service; and
the information source is separate from the object labeling server system.

19. The object labeling server system of claim 16, wherein:
the disambiguation of a set of keywords within the set of object data depends on the context of the keywords within the set of object data; and
the object labeling application configures the processor to determine the context of the keywords based on the grammatical context of the keyword within the set of object data.

20. The object labeling server system of claim 19, wherein the disambiguation of a keyword includes substituting an updated keyword taken from the disambiguation database for the keyword.

21. The object labeling server system of claim 19, wherein the disambiguation of a keyword includes adding additional keywords taken from the disambiguation database to the set of object data.

22. A method for labeling sets of objects, comprising:
obtaining a set of object data using an object labeling server system, where the object data comprises a set of keywords;
scoring the object data in the set of object data based on a taxonomy using the object labeling server system, where the taxonomy comprises resource data, category information describing the resource data, relationships between the category information and resource data, and relationships between the category information;
clustering the object data into group of object data based on the scores using the object labeling server system, where pieces of object data in a group of object data have similar scores;
determining category data for at least one of the groups of object data based on the taxonomy using the object labeling server system, where the category data comprises category information taken from the taxonomy based on the keywords associated with the pieces of object data within a group of object data; and
generating a label for at least one of the groups of object data based on the determined category data for the group of object data using the object labeling server system.
